(19) United States
(12) Patent Application Publication
(10) Pub. No.: US 2011/0085054 A1
(43) Pub. Date: Apr. 14, 2011

(54) APPARATUS AND METHOD OF REDUCING POWER CONSUMPTION IN DIGITAL IMAGE PROCESSOR

(75) Inventors: Jong-kwan Choi, Suwon-si (KR); Tak-kyoum Kim, Suwon-si (KR)

(73) Assignee: Samsung Electronics Co., Ltd., Suwon-si (KR)

(21) Appl. No.: 12/902,199

(22) Filed: Oct. 12, 2010

(30) Foreign Application Priority Data
Oct. 13, 2009 (KR) 10-2009-0097440

(51) Int. Cl. H04N 5/76; H04N 5/225; G06F 3/048

(52) U.S. Cl. 348/231.3; 348/372; 715/764; 348/E05.024

(57) ABSTRACT

An apparatus and method for reducing power consumption in a digital image processor are disclosed. The apparatus includes a global positioning system (GPS) module using power and configured to generate initial GPS location information of the digital image processor; and a digital signal processor (DSP) configured to receive the initial GPS location information, to set user selected location information for recording in a captured image, and to cut the power to the GPS module. The method includes supplying power to a global positioning system (GPS) module; receiving initial GPS location information of the digital image processor, wherein the initial GPS location is generated by the GPS module; setting a user selected location information to capture an image; and cutting the power to the GPS module.

### CROSS-REFERENCE TO RELATED PATENT APPLICATION

This application claims the benefit of Korean Patent Application No. 10-2009-0097440, filed on Oct. 13, 2009, in the Korean Intellectual Property Office, the entire disclosure of which is incorporated herein by reference.

### BACKGROUND OF THE INVENTION

1. Field of the Invention

The present invention relates to an apparatus and method of reducing power consumption in a digital image processor, wherein power consumption of a global positioning (GPS) module that determines a current location thereof by receiving a satellite signal from a GPS satellite is reduced.

2. Description of the Related Art

Apparatuses for processing a digital image include digital cameras, personal digital assistants (PDAs), phone cameras, and personal computer (PC) cameras, which process an image or use an image sensor.

The apparatuses may process an image received through an image pickup device by using a digital signal processor (DSP), generate an image file by compressing the processed image, and store the image file in a memory.

Also, the apparatuses may display an image file received through the image pickup device or stored in a storage medium on a displayer, such as a liquid crystal display (LCD).

The apparatuses may include a global positioning system (GPS) module, and may determine a current location thereof by receiving a satellite signal from a GPS satellite through the GPS module.

The GPS module may add value to the apparatus by providing the user with location information.

### SUMMARY OF THE INVENTION

An apparatus for reducing power consumption in a digital image processor is disclosed. The apparatus for reducing power consumption in a digital image processor includes a global positioning system (GPS) module using power and configured to generate initial GPS location information of the digital image processor; and a digital signal processor (DSP) configured to receive the initial GPS location information, to set user selected location information for recording in a captured image, and to cut the power to the GPS module.

The DSP may be configured to record the set user selected location information in a captured image.

The DSP may be configured to record the received GPS initial location information in the captured image.

The GPS module may include a GPS power supply configured to supply power and cut power to the GPS module according to a supply power signal or cut power signal received from the DSP.

The DSP may include a user interface (UI) provider configured to provide a UI to set the user selected location information for recording in a captured image; a location setter configured to set the user selected location on the UI; a location storage unit configured to store the set user selected location information and the initial GPS location information received from the GPS module; and a controller configured to cut the power to the GPS module and configured to record the set user selected location information in the captured image.

The UI provider may be configured to provide map information or regional name information for setting the user selected location information based on the initial GPS location.

The controller may be configured to record the received initial GPS location information in the captured image.

The controller may be configured to respond to a photographing location change received from a user, by supplying the power to the GPS module, providing the UI to set the user selected location information, and responsive to the user selecting a new user selected location information, storing the new user selected location information, and storing a new initial GPS location information received from the GPS module.

An apparatus for reducing power consumption is disclosed. The apparatus for reducing power consumption may include a global positioning system (GPS) module using power and configured to generate initial location information of the digital image processor; and a digital signal processor (DSP) configured to receive the initial location information and configured to cut the power to the GPS module.

The DSP may be configured to record the received initial location information in a captured image.

The GPS module may include a GPS power supply configured to supply power and to cut power to the GPS module according to a supply power signal or cut power control signal received from the DSP.

The DSP may include a location storage unit configured to store the initial location information received from the GPS module; and a controller configured to cut the power to the GPS module and configured to record the initial location information in the captured image.

The controller may be configured to respond to a photographing location change by supplying power to the GPS module, and by storing the initial location information re-received from the GPS module.

A method of reducing power consumption in a digital image processor is disclosed. The method may include supplying power to a global positioning system (GPS) module; receiving initial GPS location information of the digital image processor, wherein the initial GPS location is generated by the GPS module; setting a user selected location information to capture an image; and cutting the power to the GPS module.

The method of reducing power consumption in a digital image processor may include capturing an image; and recording the user selected location information in the captured image. The method of reducing power consumption in a digital image processor may include capturing an image; and recording the initial GPS location information in the captured image.

Setting may include providing a user interface (UI) for setting the user selected location information for recording in the captured image, wherein the UI provides location information based on the initial GPS location; receiving a selection from the user of the user selected location information; and storing the user selected location information.

The method of reducing power consumption in a digital image processor may include responsive to receiving a change in location from the user, supplying power to the global positioning system (GPS) module; receiving a new initial GPS location information of the digital image processor, wherein the new initial GPS location is generated by the GPS module; setting the user selected location information to capture an image; and cutting the power to the GPS module.

The UI is a map or a menu for selecting regional names for setting the user selected location information.

A method of reducing power consumption in a digital image processor is disclosed. The method of reducing power consumption in a digital image processor may include supplying power to a global positioning system (GPS) module; receiving initial location information of the digital image processor, wherein the initial location information is generated by the GPS module; storing the initial location information; and cutting the power to the GPS module.

The method of reducing power consumption in a digital image processor may include capturing an image; and recording the initial location information in the captured image. The method may further include, after the cutting of the power: capturing an image; and recording the received initial location information of the digital image processor in the captured image.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an example of an apparatus for reducing power consumption in a digital image processor;

FIG. 2 is a block diagram of an example of a digital signal processor (DSP) and an example of a global positioning system (GPS) module of FIG. 1;

FIG. 3 are diagrams of an example of a user interface provided by the DSP of FIG. 2;

FIG. 4 is a block diagram of the DSP and the GPS module of FIG. 1;

FIG. 5 are diagrams of an exchangeable image file format (Exif) structure in a Joint Photographic Coding Experts Group (JPEG) file to which location information is input;

FIGS. 6A and 6B are flowcharts illustrating an example of a method of reducing power consumption in a digital image processor; and

FIG. 7 is a flowchart illustrating an example of a method of reducing power consumption in a digital image processor.

### DETAILED DESCRIPTION OF THE INVENTION

Hereinafter, the present invention will be described more fully with reference to the accompanying drawings, in which exemplary embodiments of the invention are shown.

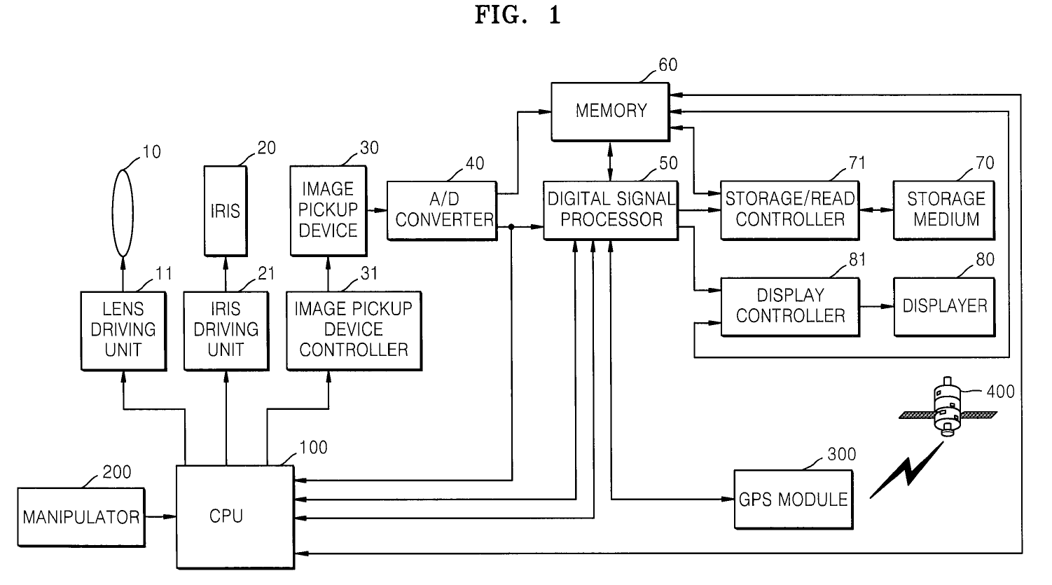

FIG. 1 is a block diagram of an example of an apparatus for reducing power consumption in a digital image processor.

The example apparatus is not limited to being applied to the digital image processor, and may be applied to an image processing apparatus, such as a personal digital assistant (PDA), a cellular telephone, or a personal multimedia player (PMP).

Operation of an apparatus for processing a digital image is controlled by a central processing unit (CPU) 100. Also, the apparatus for processing a digital image includes a manipulator 200 including keys for generating an electric signal by a user, or the like. The electric signal from the manipulator 200 is transmitted to the CPU 100, and the CPU 100 may control the apparatus for processing a digital image according to the electric signal.

In a photographing mode, the user inputs the electric signal to the CPU 100 through the manipulator 200, and the CPU 100 controls a lens driving unit 11, an iris driving unit, and an image pickup device controller 31 according to the electric signal, thereby controlling a location of a lens 10, an aperture of an iris 20, and sensitivity of an image pickup device 30. The image pickup device 30 generates analog signal from received light, and an analog/digital (A/D) converter 40 converts analog signal output from the image pickup device 30 into digital data. Here, the A/D converter 40 may not be required according to the characteristics of the image pickup device 30.

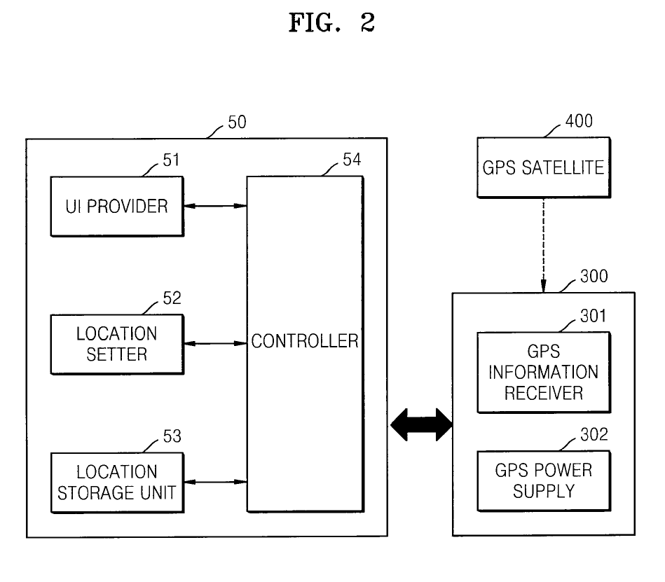

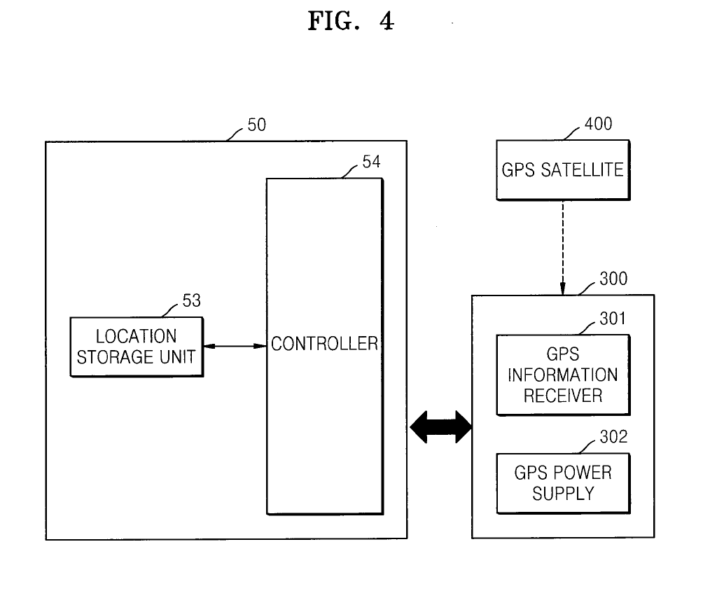

The digital data from the A/D converter 40 may be input to the DSP 50 directly or through a memory 60, and also input to the CPU 100 if required. Here, the memory 60 may be a read-only memory (ROM) or a random access memory (RAM). The DSP 50 may perform a process, such as gamma correction or white balance, on a digital signal as occasion demands. The DSP 50 may include elements, such as a user interface (UI) provider 51, a location setter 52, a location storage unit 53, and a controller 54, as will be described later with reference to FIGS. 2 and 4. However, the UI provider 51, the location setter 52, the location storage unit 53, and the controller 54 may be separate elements instead of being included in the DSP 50, and operations of thereof will be described later.

An image of the data output from the DSP 50 may be transmitted to a display controller 81 directly or through the memory 60. The display controller 81 displays an image on a displayer 80 by controlling the displayer 80. The displayer 80 may be a touch screen. Also, the data output from the DSP 50 may be input to a storage/read controller 71 directly or through the memory 60. The storage/read controller 71 may store the data in a storage medium 70 automatically or according to a signal from the user. The storage/read controller 71 may read data from an image file stored in the storage medium 70, and input the read data to the display controller 81 through the memory 60 or through another path so as to display an image of the image file on the displayer 80. The storage medium 70 may be detachable from or fixed to the apparatus for processing a digital image.

Meanwhile, the GPS module 300 may be installed inside or outside the digital image processor.

The GPS module 300 may receive a satellite signal from a GPS satellite 400 so as to determine a current location coordinates of the digital image processor. Also, the GPS module 300 may determine a moved distance of the digital image processor from the change of a location coordinate according to time. The GPS module 300 may include a GPS information receiver 301 and a GPS power supply 302 as shown in FIGS. 2 and 4, which will be described later.

The DSP 50 and the GPS module 300 will now be described with reference to FIGS. 2 through 5. FIG. 2 is a block diagram of the digital signal processor 50 and the GPS module 300 of FIG. 1.

The GPS information receiver 301 may determine a current location coordinates of the digital image processor by receiving the satellite signal from the GPS satellite 400. Also, the GPS information receiver 301 may determine a moved distance of the digital image processor from the change of a location coordinate according to time.

The GPS information receiver 301 may determine locations of the GPS satellite 400 and the GPS information receiver 301 by receiving satellite signals transmitted from at least three GPS satellites 400. A distance between the GPS satellite 400 and the GPS information receiver 301 may be obtained by measuring a difference between a point of time when the GPS satellite 400 transmitted the satellite signal and a point of time when the GPS information receiver 301 received the satellite signal.

Here, the satellite signal transmitted from the GPS satellite 400 includes information about a location of the GPS satellite 400. Accordingly, when the locations of the at least three GPS satellites 400 and the distances between the GPS information receiver 301 and the at least three GPS satellites 400 are determined, the location of the GPS information receiver 301 may be determined by using a triangulation method, or the like. However, since a clock of the GPS information receiver 301 may not be accurate, at least four GPS satellites 400 may be used in order to correct the error.

The GPS power supply 302 supplies or cuts the power that operates the GPS module 300 according to a control signal of the DSP 50.

When the digital image processor is booted on, i.e., when the GPS module 300 is turned on, the DSP 50 receives initial location information from the GPS module 300, and cuts the power to the GPS module 300, and sets location information to capture an image.

The example of a DSP 50 includes the UI provider 51, the location setter 52, the location storage unit 53, and the controller 54.

When the GPS module 300 is turned on as the digital image processor is booted, the controller 54 receives the initial location information from the GPS module 300, and stores the received initial location information in the location storage unit 53.

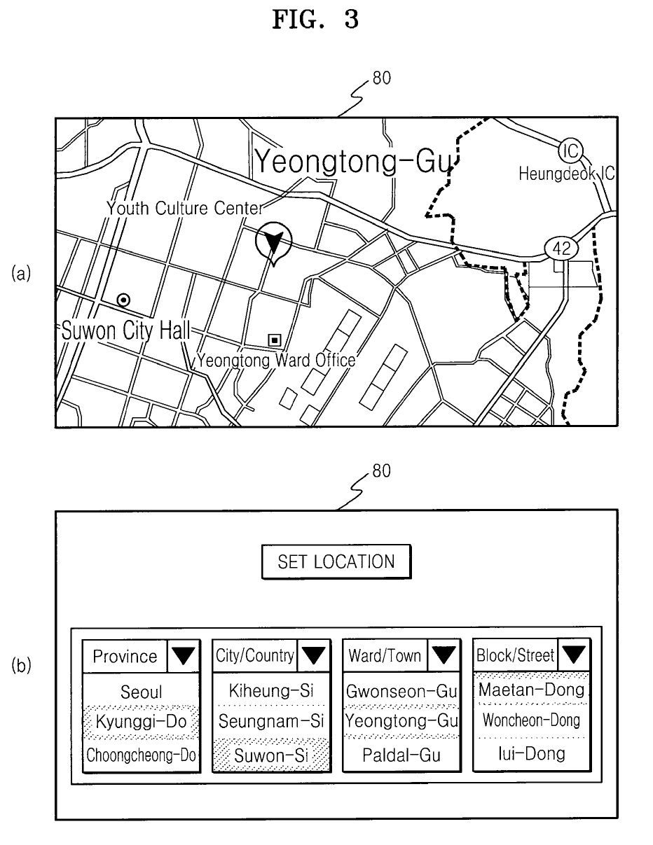

After the initial location information of the digital image processor is stored, the UI provider 51 provides a UI for setting the location information to be recorded in a captured image. FIG. 3 are examples of diagrams of a UI provided by the DSP 50 of FIG. 2. The UI provided by the UI provider 51 may be a map as shown in FIG. 3 (a), or a menu for selecting regional names as shown in FIG. 3 (b), and may be displayed on the displayer 80.

The location setter 52 sets the location information to capture an image on the UI provided by the UI provider 51. For example, the location setter 52 may set the location information to be in the vicinity of Yeongtong-Gu in the map of FIG. 3 (a), or Maetan-Dong, Yeongtong-Gu, Suwon-Si, Kyunggi-Do in the menu of FIG. 3 (b).

The location storage unit 53 stores the location information set by the location setter 52. Also, the location storage unit 53 stores the initial location information received from the GPS module 300 when the GPS module 300 is turned on.

After the initial location information has been received, the controller 54 outputs a cut power control signal for cutting the power to the GPS module 300, and upon receiving the cut power control signal, the GPS power supply 302 cuts the power to the GPS module 300. In embodiments, the GPS power supply 302 is not part of the GPS module 300, but may be part of another module of the apparatus or may be a separate module. The controller 54 records the location information, which is set on the UI and stored in the location storage unit 53, in the captured image. Also, the controller 54 may record the initial location information, which is stored in the location storage unit 53 after being received from the GPS module 300, in the captured image.

When the location information changes according to the set location information, the controller 54 outputs a supply power control signal for supplying power to the GPS module 300, and upon receiving the supply power control signal, the GPS power supply 302 supplies the power to the GPS module 300. After the power is supplied to the GPS module 300, the controller 54 receives the initial location information from the GPS module 300, stores the received initial location information in the location storage unit 53, operates the UI provider 51 so as to re-set the location information, and stores the location information re-set on the UI in the location storage unit 53. The controller 54 cuts the power to the GPS module 300 after receiving the initial location information, and when the image is captured, records the re-set location information in the captured image.

As such, the location information may be recorded in the captured image without always turning on the GPS module 300, and since the GPS module 300 is turned off, power consumption of the GPS module 300 is reduced, thereby increasing battery durability of the digital image processor.

FIG. 4 is a block diagram of an example of the DSP 50 and the GPS module 300 of FIG. 1. According to the previous example, the location information is set through the UI, and the power to the GPS module 300 is cut and the location information is recorded in the captured image. However, according to the current example, the GPS module 300 is turned on as the digital image processor is booted, the initial location information is received from the GPS module 300, and the power to the GPS module 300 is cut and the initial location information is recorded in the captured image.

When the digital image processor is booted, i.e. when the GPS module 300 is turned on, the DSP 50 according to the current example receives and stores the initial location information from the GPS module 300, and cuts the power to the GPS module 300 after receiving the initial location information.

Accordingly, the DSP 50 includes the location storage unit 53 and the controller 54.

When the GPS module 300 is turned on as the digital image processor is booted, the controller 54 receives the initial location information from the GPS module 300, and stores the received initial location information in the location storage unit 53.

After receiving the initial location information, the controller 54 outputs a cut power control signal for cutting the power to the GPS module 300, and upon receiving the cut power control signal, the GPS power supply 302 cuts the power to the GPS module 300. The controller 54 records the initial location information stored in the location storage unit 53 in the captured image.

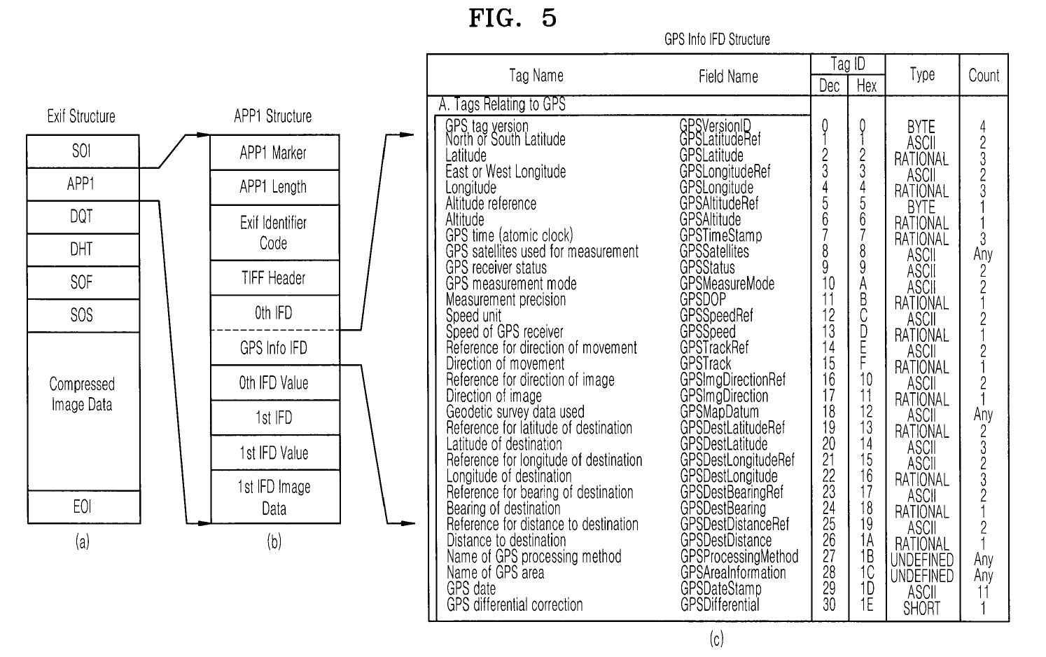

FIG. 5 are diagrams of an exchangeable image file format (Exif) structure in a Joint Photographic Coding Experts Group (JPEG) file to which location information is input. FIG. 5 (a) illustrates the Exif structure in an image file (the JPEG file) generated according to the DSP 50. In FIG. 5 (a), photographing day and time of compressed image data, additional information such as a product name, or thumbnail information is recorded in an application marker segment 1 (APP1) area of the Exif structure. FIG. 5 (b) illustrates an APP1 structure. In FIG. 5 (b), the APP1 structure includes a GPS info image file directory (IFD) area in a 0^{th} IFD area. The DSP 50 stores the initial location information stored in the location storage unit 53 in a GPS info IFD area. FIG. 5 (c) illustrates the GPS info IFD structure, and the location information, such as a GPS version, latitude, longitude, altitude, speed, timestamp, and satellite information, is stored in the GPS info IFD area.

When the location information changes after capturing the image according to the location information, the controller 54 outputs a supply power control signal for supplying power to the GPS module 300, and upon receiving the supply power control signal, the GPS power supply 302 supplies the power to the GPS module 300. After the power is supplied to the GPS module 300, the controller 54 re-receives the initial location information from the GPS module 300, stores the re-received initial location information in the location storage unit 53, cuts the power to the GPS module 300, and when the image is captured, records the re-received initial location information in the captured image.

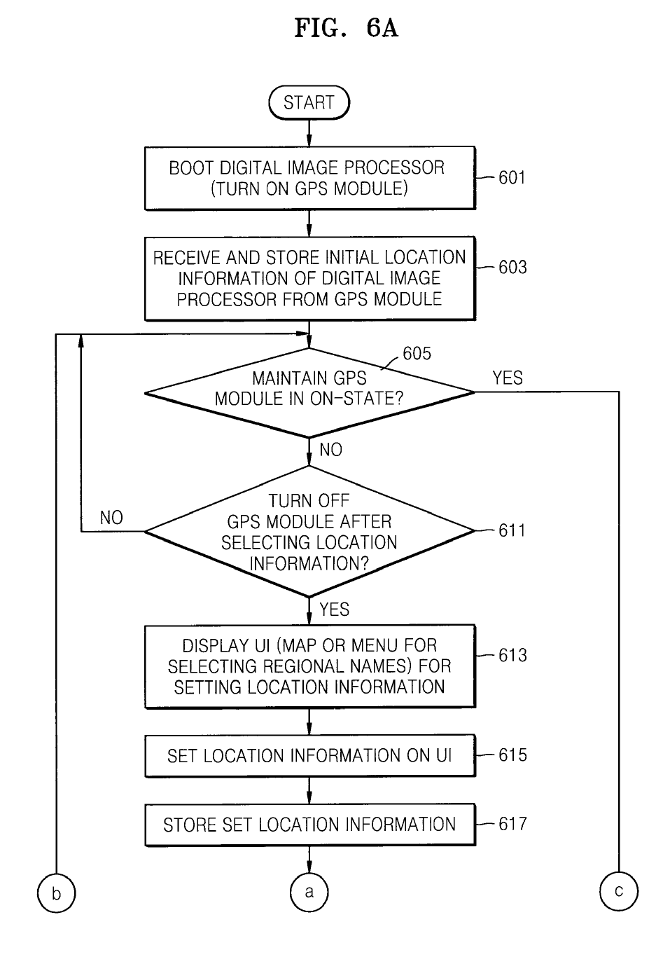

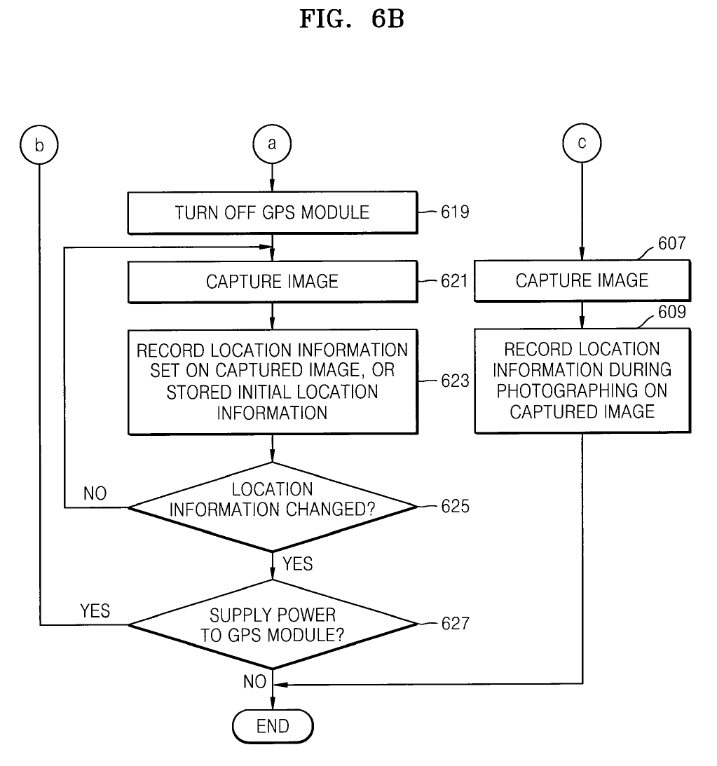

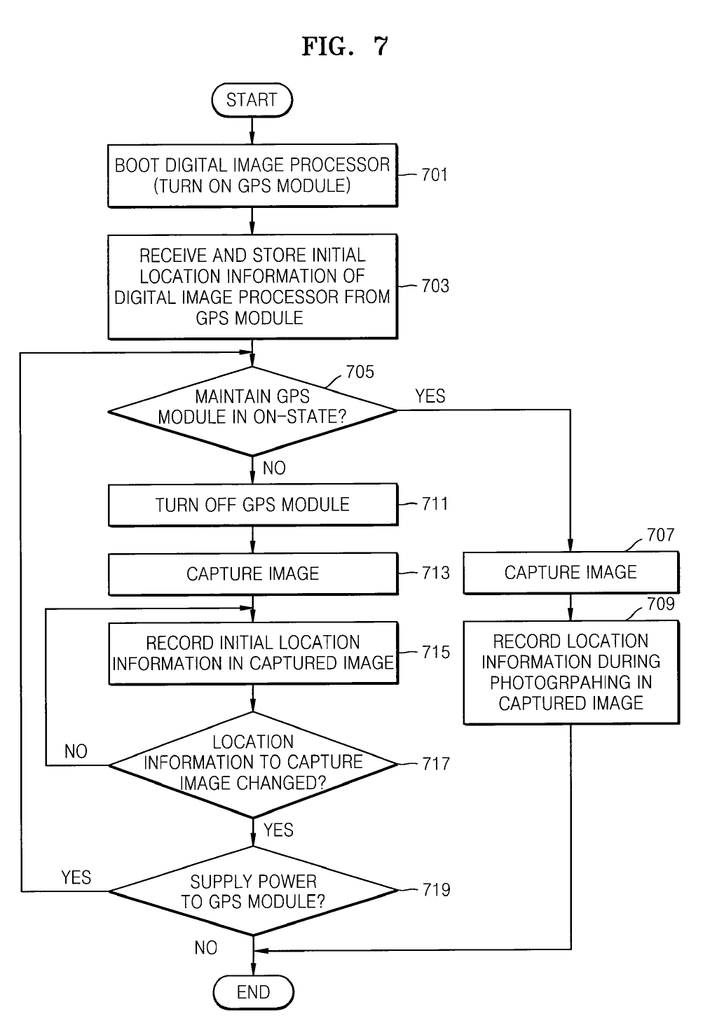

A example of a method of reducing power consumption in a digital image processor will now be described with reference to FIGS. 6 and 7. The method may be performed by the apparatus for processing a digital image of FIG. 1, and according to an embodiment, the method may be performed by the DSP 50 with help from peripheral elements of the apparatus for processing a digital image.

FIGS. 6A and 6B are flowcharts illustrating an example of a method of reducing power consumption in a digital image processor.

When the digital image processor is booted, the DSP 50 turns on the GPS module 300, in operation 601. When the digital image processor is booted, the DSP 50 outputs a supply power control signal to the GPS module 300, and the GPS power supply 302 supplies power to the GPS module 300.

When the GPS module 300 is turned on, the DSP 50 receives and stores initial location information of the digital image processor from the GPS information receiver 301, in operation 603. The initial location information includes a GPS version, latitude, longitude, altitude, speed, timestamp, and satellite information

Then, the DSP 50 determines whether to maintain the GPS module 300 in an ON-state, in operation 605, and if a signal for maintaining the GPS module 300 in the ON-state is received from a user, location information during photographing is recorded in operation 609 on an image captured in operation 607. A format of the location information recorded in an Exif structure of an image file (JPEG file) is identical to that of FIG. 5.

Otherwise, if a signal for maintaining the GPS module 300 in an OFF-state is received from the user, the DSP 50 selects the location information, and determines whether to turn off the GPS module 300, in operation 611.

If a signal for turning the GPS module 300 off is received from the user after selecting the location information, the DSP 50 displays a UI for setting the location information on the displayer 80, in operation 613. The UI provided by the DSP 50 may be the map as shown in FIG. 3 (a) or the menu for selecting regional names as shown in FIG. 3 (b).

Then, the DSP 50 receives a signal for setting the location information on the UI from the user, in operation 615. For example, the location information may be set to be in the vicinity of Yeongtong-Gu in the map of FIG. 3 (a) or Maetan-Dong, Yeongtong-Gu, Suwon-Si, Kyunggi-Do from the menu of FIG. 3(b).

When the location information is set, the DSP 50 stores the set location information in operation 617, and turns off the GPS module 300 in operation 619. The DSP 50 outputs a cut power control signal for cutting the power to the GPS module 300, and upon receiving the cut power control signal, the GPS power supply 302 cuts the power to the GPS module 300.

When an image is captured in operation 621, the DSP 50 records the set location information in the captured image in operation 623. Here, the DSP 50 may record the stored initial location information in the captured image.

Next, the DSP 50 determines whether the location information is changed in operation 625. If the location information is changed, the DSP 50 determines whether to supply power to the GPS module 300 in operation 627.

If a signal for supplying power to the GPS module 300 is received from the user, the DSP 50 performs operation 605 so as to output a supply power control signal for supplying power to the GPS module 300, and upon receiving the supply power control signal, the GPS power supply 302 supplies the power to the GPS module 300. After the power is supplied to the GPS module 300, the DSP 50 receives and stores the initial location information from the GPS module 300, provides a UI for re-setting the location information, and then stores the re-set location information. Next, the DSP 50 cuts the power to the GPS module 300, and records the re-set location information in the captured image.

FIG. 7 is a flowchart illustrating an example of a method of reducing power consumption in a digital image processor.

According to the example method described above, the location information to capture an image is set through the UI, the power to the GPS module 300 is cut, and the set location information is recorded in the captured image; however, according to the method of the current example, the digital image processor is booted, the initial location information is received from the GPS module 300 as the GPS module 300 is turned on, the power to the GPS module 300 is cut, and the initial location information is recorded in the captured image.

When the digital image processor is booted, the DSP 50 turns on the GPS module 300 in operation 701. When the digital image processor is booted, the DSP 50 outputs a supply power control signal to the GPS module 300, and upon receiving the supply power control signal, the GPS power supply 302 supplies the power to the GPS module 300.

After the GPS module 300 is turned on, the DSP 50 receives and stores initial location information of the digital image processor from the GPS information receiver 301 in operation 703. The initial location information includes a GPS version, latitude, longitude, altitude, speed, timestamp, and satellite information.

Then, the DSP 50 determines whether to maintain the GPS module 300 in an ON-state in operation 705. If a signal for maintaining the GPS module 300 in an ON-state is received from a user, location information during photographing is recorded in operation 709 in an image captured in operation 707.

Otherwise, if a signal for maintaining the GPS module 300 in an OFF-state is received, the DSP 50 turns off the GPS module 300 in operation 711. The digital image processor stores the initial location information of the digital image processor, and the DSP 50 outputs a cut power control signal for cutting the power to the GPS module 300, and upon receiving the cut power control signal, the GPS power supply 302 cuts the power to the GPS module 300.

Then, when an image is captured in operation 713, the DSP 50 records the initial location information in the captured image in operation 715.

Next, the DSP 50 determines whether location information to capture an image is changed in operation 717. The DSP 50 may determine whether location information to capture an image is changed based on user input. If the location information is changed, the GPS module 300 determines whether to supply power to the GPS module 300 in operation 719.

If a signal for supplying power to the GPS module 300 is received from the user, the DSP 50 performs operation 705 so as to output a supply power control signal for supplying power to the GPS module 300, and upon receiving the supply power control signal, the GPS power supply 302 supplies the power to the GPS module 300. When the power is supplied to the GPS module 300, the DSP 50 receives and stores the initial location information from the GPS module 300. Then, the DSP 50 cuts the power to the GPS module 300, and when an image is captured, records the re-set initial location information in the captured image.

In embodiments, the location information may be recorded in an image without always maintaining a GPS module in an ON-state. And, since the GPS module can be turned off, power consumption of the GPS module is reduced, thereby increasing battery durability of a digital image processor. In embodiments, when a new location is not required to be determined, the GPS module is not used, and thus the GPS module may not consume unnecessary power.

The various illustrative logics, logical blocks, and modules described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. An apparatus for reducing power consumption in a digital image processor, the apparatus comprising:
a global positioning system (GPS) module using power and configured to generate initial GPS location information of the digital image processor; and
a digital signal processor (DSP) configured to receive the initial GPS location information, to set user selected location information for recording in a captured image, and to cut the power to the GPS module.

2. The apparatus of claim 2, wherein the DSP is configured to record the set user selected location information in a captured image.

3. The apparatus of claim 2, wherein the DSP is configured to record the received GPS initial location information in the captured image.

4. The apparatus of claim 2, wherein the GPS module comprises a GPS power supply configured to supply power and cut power to the GPS module according to a supply power signal or cut power signal received from the DSP.

5. The apparatus of claim 1, wherein the DSP comprises:
a user interface (UI) provider configured to provide a UI to set the user selected location information for recording in a captured image;
a location setter configured to set the user selected location on the UI;
a location storage unit configured to store the set user selected location information and the initial GPS location information received from the GPS module; and
a controller configured to cut the power to the GPS module and configured to record the set user selected location information in the captured image.

6. The apparatus of claim 5, wherein the UI provider is configured to provide map information or regional name information for setting the user selected location information based on the initial GPS location information.

7. The apparatus of claim 5, wherein the controller is configured to record the received initial GPS location information in the captured image.

8. The apparatus of claim 5, wherein the controller is configured to respond to a photographing location change received from a user, by supplying the power to the GPS module, providing the UI to set the user selected location information, and responsive to the user selecting a new user selected location information, storing the new user selected location information, and storing a new initial GPS location information received from the GPS module.

9. An apparatus for reducing power consumption in a digital image processor, the apparatus comprising:
a global positioning system (GPS) module using power and configured to generate initial location information of the digital image processor; and
a digital signal processor (DSP) configured to receive the initial location information and configured to cut the power to the GPS module.

10. The apparatus of claim 9, wherein the DSP is configured to record the received initial location information in a captured image.

11. The apparatus of claim 9, wherein the GPS module comprises a GPS power supply configured to supply power and to cut power to the GPS module according to a supply power signal or cut power control signal received from the DSP.

12. The apparatus of claim 9, wherein the DSP comprises:
a location storage unit configured to store the initial location information received from the GPS module; and
a controller configured to cut the power to the GPS module and configured to record the initial location information in the captured image.

13. The apparatus of claim 12, wherein the controller is configured to respond to a photographing location change by supplying power to the GPS module, and by storing the initial location information re-received from the GPS module.

14. A method of reducing power consumption in a digital image processor, the method comprising:
supplying power to a global positioning system (GPS) module;
receiving initial GPS location information of the digital image processor, wherein the initial GPS location is generated by the GPS module;
setting a user selected location information to capture an image; and
cutting the power to the GPS module.

15. The method of claim 14, further comprising:
capturing an image; and
recording the user selected location information in the captured image.

16. The method of claim 14, further comprising:
capturing an image; and
recording the initial GPS location information in the captured image.

17. The method of claim 14, wherein setting comprises:
providing a user interface (UI) for setting the user selected location information for recording in the captured image, wherein the UI provides location information based on the initial GPS location;
receiving a selection from the user of the user selected location information; and
storing the user selected location information.

18. The method of claim 17, further comprising:
responsive to receiving a change in location from the user,
supplying power to the global positioning system (GPS) module;
receiving a new initial GPS location information of the digital image processor, wherein the new initial GPS location is generated by the GPS module;
setting the user selected location information to capture an image; and
cutting the power to the GPS module.

19. The method of claim 14, wherein the UI is a map or a menu for selecting regional names for setting the user selected location information.

20. A method of reducing power consumption in a digital image processor, the method comprising:
supplying power to a global positioning system (GPS) module;
receiving initial location information of the digital image processor, wherein the initial location information is generated by the GPS module;
storing the initial location information; and
cutting the power to the GPS module.

21. The method of claim 20, further comprising:
capturing an image; and
recording the initial location information in the captured image.
